(19) United States
(12) Patent Application Publication
(10) Pub. No.: US 2025/0343009 A1
(43) Pub. Date: Nov. 6, 2025

(54) APPARATUS FOR MOUNTING A DC CHOKE TO A DC LINK CAPACITOR

(71) Applicant: Rivian IP Holdings, LLC, Irvine, CA (US)

(72) Inventors: Che Daniel SILKISS-HERO, Long Beach, CA (US); Juan LOPEZ, Wildomar, CA (US); Navin PILLAI, Carson, CA (US); Young DOO, La Palma, CA (US)

(21) Appl. No.: 18/652,066

(22) Filed: May 1, 2024

(51) Int. Cl. H01G 4/38; H01G 4/224; H02M 1/14

(52) U.S. Cl. CPC H01G 4/38; H01G 4/224; H02M 1/143

(57) ABSTRACT

A capacitor assembly includes a capacitor housing containing a capacitor, the capacitor housing defining at least one capacitor fastener opening and at least one capacitor feature. The capacitor includes a first input terminal and a second input terminal. A direct current (DC) choke defines a terminal opening having the first and second input terminals extending outwardly therefrom. The DC choke defines at least one choke fastener opening configured to receive at least one fastener passing through the at least one capacitor fastener opening. The DC choke further defines at least one choke feature configured to engage the at least one capacitor feature to maintain a position of the DC choke relative to the capacitor housing.

### INTRODUCTION

The present disclosure relates to a direct current (DC) choke for a power module, such as for the input contacts of a DC link capacitor.

### SUMMARY

The present disclosure describes an approach for assembling a DC link capacitor and DC choke. In one aspect, a capacitor assembly includes a capacitor housing containing a capacitor, the capacitor housing defining at least one capacitor fastener opening and at least one capacitor feature. The capacitor includes a first input terminal and a second input terminal. A direct current (DC) choke defines a terminal opening having the first and second input terminals extending outwardly therefrom. The DC choke defines at least one choke fastener opening configured to receive at least one fastener passing through the at least one capacitor fastener opening. The DC choke further defines at least one choke feature configured to engage the at least one capacitor feature to maintain a position of the DC choke relative to the capacitor housing.

In another aspect, a method includes moving a direct current (DC) choke over first and second input terminals of a DC link capacitor along an insertion direction while also moving at least one choke feature secured to the DC choke into engagement with at least one capacitor feature secured to the DC link capacitor. The engagement of the at least one choke feature with the at least one capacitor feature resists movement of the DC choke relative to the DC link capacitor. The method further includes inserting one or more fasteners in a first direction through the DC choke and the DC link capacitor to fasten the DC choke to the DC link capacitor, the first direction being substantially perpendicular to the insertion direction.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating power electronics of a vehicle in accordance with certain embodiments.

FIGS. 4A and 4B are isometric views of a power electronics housing containing power electronics and a DC link capacitor in accordance with certain embodiments.

FIG. 5A is an exploded view of a DC link capacitor in accordance with certain embodiments.

FIG. 5B is an assembled view of the DC link capacitor in accordance with certain embodiments.

FIG. 6 is an isometric view of a DC choke in accordance with certain embodiments.

FIG. 7 is a partial isometric view illustrating operation of a fastening feature in accordance with certain embodiments.

FIG. 8 is a partial isometric view illustrating operation of an anti-rotation feature in accordance with certain embodiments.

FIG. 9 is a partial isometric view illustrating an assembled DC choke and DC link capacitor in accordance with certain embodiments.

### DETAILED DESCRIPTION

A DC choke is assembled with a DC link capacitor prior to mounting within a housing containing power electronics. The DC choke includes an opening receiving input terminals of the DC link capacitor along an insertion direction. The DC choke further includes one or both of a fastening feature and an anti-rotation feature that engage corresponding features on a housing of the DC link capacitor. The fastening feature engages easily (e.g., without use of a fastening tool) and resists removal of the DC choke from the DC link capacitor along an insertion direction. As used herein, the phrase “without use of a fastening tool” refers to attachment without use of a tool used to engage a fastener, such as a screw driver, nut driver, wrench, rivet tool, or the like. The phrase “without use of a fastening tool” does not preclude the use of a tool to pick up and place the DC choke, such as a gripper on a robotic arm, a mounting jig, or the like. The anti-rotation feature resists rotation in a plane parallel to the insertion direction.

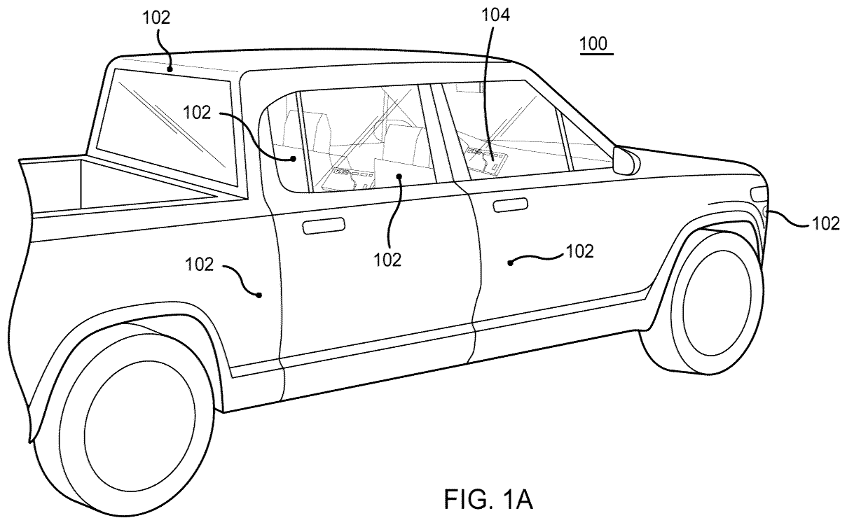

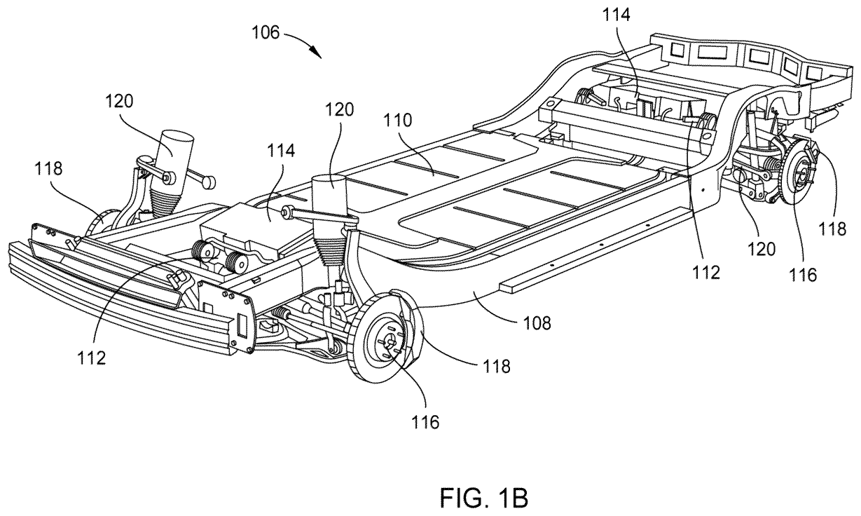

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more power modules 114, such as power electronics for each drive unit 112 or pair of drive units 112. The power module 114 may include inverters configured to convert direct current (DC) from the battery 110 into alternating current (AC) supplied to the motors of the drive units 112. The power module 114 further facilitates operation of the motors of the drive units 112 as generators to provide regenerative braking. The power module 114 further facilitates the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein.

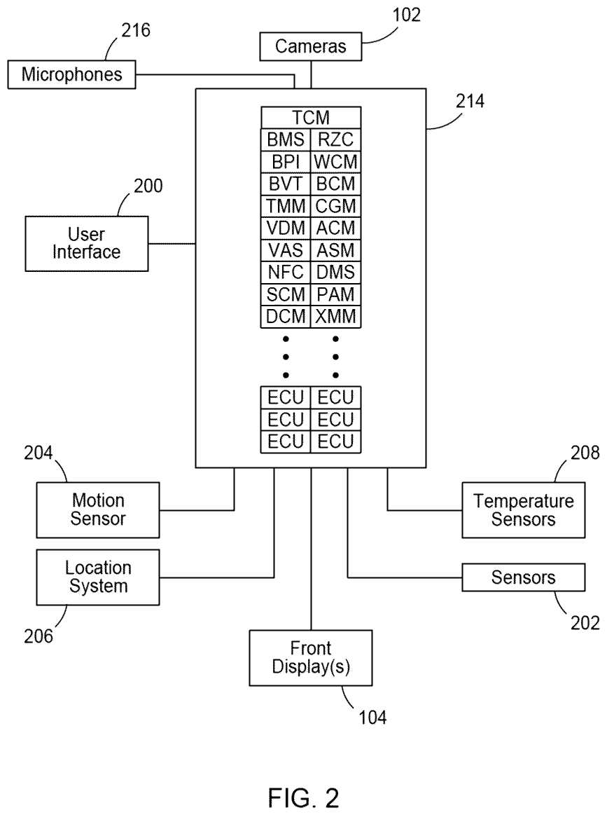

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114.

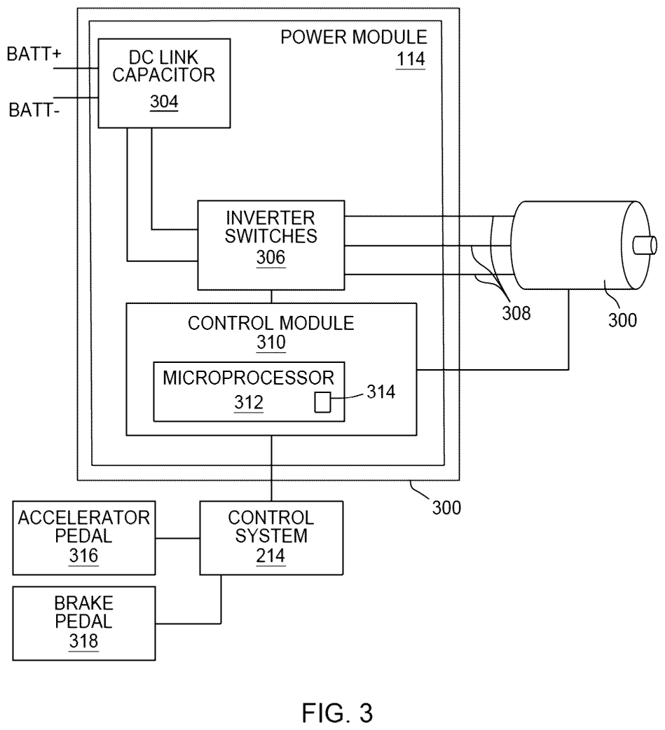

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the power module 114 may be contained within a housing 300, such as a housing made of aluminum or steel. The power module 114 may include a plurality of components configured to convert direct current (DC) from the battery 110 into alternating current (AC), such as three-phase AC, supplied to one or more motors 302 of the drive unit 112 including the power module 114.

The power module 114 may receive power from the battery 110 by way of a DC link capacitor 304 that is coupled to the positive and negative terminals (Batt+, Batt−) of the battery 110 and functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The power module 114 may include inverter switches 306 coupled to the outputs of the DC link capacitor 304. The inverter switches 306 may include a plurality of switches that are selectively opened and closed to cause transmission of current to the outputs of the power module 114 at an appropriate frequency for driving the one or more motors 302. For example, the inverter switches 306 may output three-phase current over lines 308 connecting the inverter switches 306 to the motor 302. The opening and closing of the inverter switches 306 may be controlled by a control module 310. The control module 310 may include a printed circuit board with various electronic components configured to generate the control signals for the inverter switches 306. In some embodiments, the power module 114 drives two drive units 112 and includes separate printed circuit boards for supplying current to the motors 302 of the separate drive units.

The control module 310 may further include a microprocessor 312 programmed to control operation of the control module 310 and therefore the inverter switches 306. The microprocessor 312 may be embodied as a silicon chip mounted to the printed circuit board of the control module 310. The microprocessor 312 may include a temperature sensor 314 mounted directly thereto.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

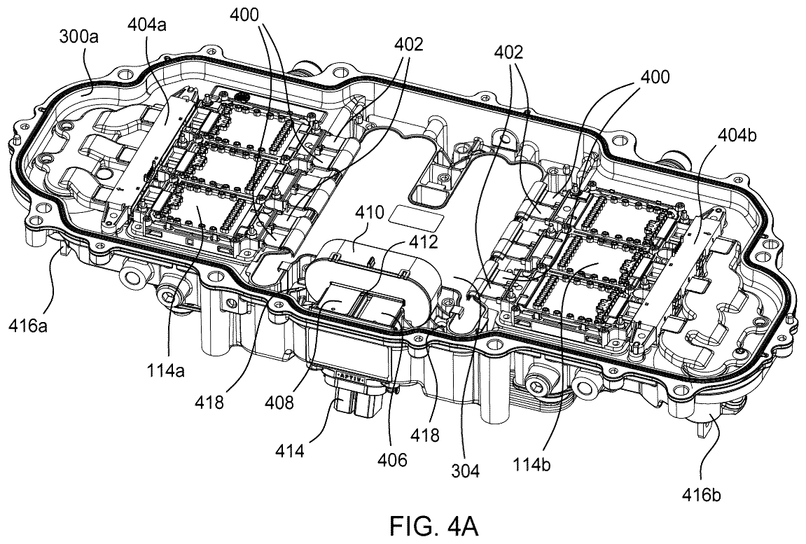

FIGS. 4A and 4B illustrate an example implementation of the power module 114, housing 300, and DC link capacitor 304. In the illustrated embodiment, the housing 300 includes a lower housing 300a and an upper housing 300b that together define a volume containing the DC link capacitor 304 and two sets of power electronics, e.g., power electronics a, 114b. As used herein “power electronics 114a, 114b” refers to a subset of components of the power module 114 that are duplicated and used to drive separate motors 302. For example, the power electronics 114a, 114b may each include inverter switches 306 and a control module 310 (including a microprocessor 312) configured to control the inverter switches 306 as described above. In the illustrated embodiment, a single DC link capacitor 304 is coupled to both power electronics 114a, 114b. However, separate DC link capacitors 304 may also be used. With the upper housing 300b secured to the lower housing 300a, the housing 300 may be sealed from ingress of air, water, or contaminants.

The power electronics 114a, 114b each connect to one or more positive output terminals 400 and one or more negative output terminals 402 of the DC link capacitor 304. For example, in the illustrated embodiment, the DC link capacitor 304 includes three positive output terminals 400 on each side interleaved with three negative output terminals 402 on each side. The positive and negative output terminals 400, 402 may be secured to the corresponding contacts (obscured by the positive and negative output terminals 400, 402 in FIG. 4A) on the power electronics 114a, 114b by means of screws, welds, or other fastening approach.

The power electronics 114a, 114b further include output terminals 404a, 404b, respectively, that each supply AC current to a different motor 302, e.g., left and right front motors 302 of a front drive unit 112 or left and right front motors 302 of a rear drive unit 112. For example, there may be a single housing 300 and corresponding power electronics 114a, 114b for a single drive unit 112 (e.g., two-wheel drive) or two housings 300 and corresponding power electronics 114a, 114b for two drive units 112 (e.g., all-wheel drive).

The DC link capacitor 304 further includes a positive input terminal 406 and a negative input terminal 408 coupled to Batt+ and Batt−, respectively. In some embodiments, the transmission of high-frequency signals to the power electronics 114a, 114b through the DC link capacitor 304 is inhibited by a DC choke 410. The DC choke 410 may be an inductive element made of wound wires, a laminate of conductive plates (e.g., metalized plastic), or other inductive structure. The DC choke 410 may define an opening 412 (i.e., a terminal opening) for receiving the positive input terminal 406 and the negative input terminal 408 with the wires, conductive laminate, or other inductive structures forming a loop around the opening 412. When the DC choke 410 and DC link capacitor 304 are mounted to the lower housing 300, the positive input terminal 406 and the negative input terminal 408 extend outwardly from the opening 412.

The positive input terminal 406 and the negative input terminal 408 may be electrically coupled to an input connector 414. The input connector 414 may provide an interface accessible from external to the housing 300 for connecting to a cable connected to the battery 110. The positive input terminal 406 and the negative input terminal 408 may secure to an input connector 414 using welds, screws, or other fastening approach.

Output connectors 416a, 416b may be connected to the output terminals 404a, 404b of the power electronics 114a, 114b, respectively. The output connectors 416a, 416b may provide an interface accessible from external to the housing for connecting cables to the motors 302 connected to the power electronics 114a, 114b.

In the illustrated embodiment, fasteners 418 secure the DC choke 410 to the DC link capacitor 304. The fasteners 418 may additionally secure the DC link capacitor 304 to the lower housing 300a. The fasteners 418 may be embodied as screws or other type of fastener.

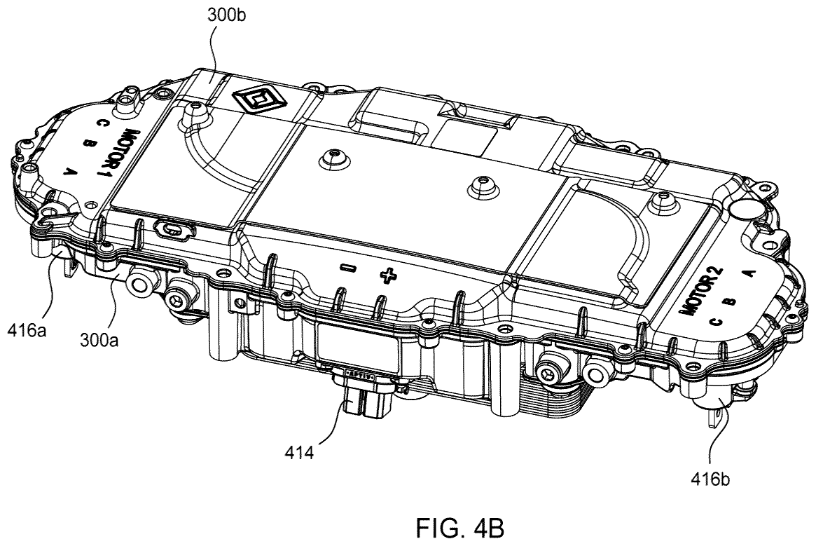

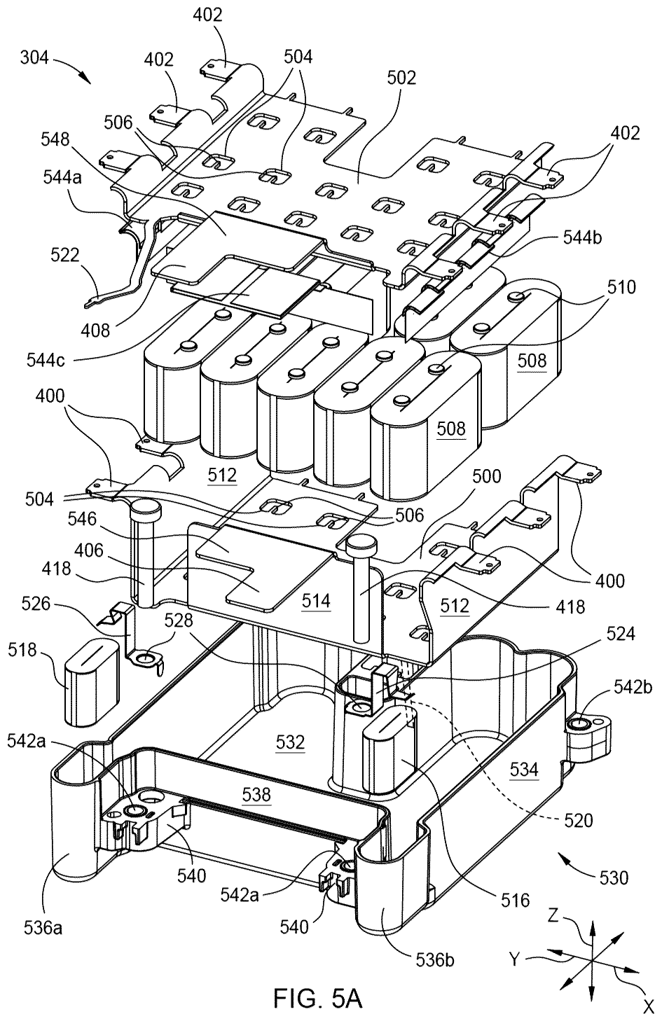

Referring to FIGS. 5A and 5B, the DC link capacitor 304 may have the illustrated configuration. The illustrated configuration may be understood with respect to X, Y, and Z directions that are mutually perpendicular. In use, the Z direction may correspond to the vertical direction (e.g., substantially parallel to the direction of gravity). However, other orientations are also acceptable. Likewise, references herein to front, back, upper, lower, upwardly, downwardly, or other positions or directions are used to facilitate understanding of the relative position and orientation of components with the understanding that the actual orientation during use may be different.

The DC link capacitor 304 may include a positive plate 500 and a negative plate 502 that are offset from one another along the Z direction and substantially (e.g., within 5 degrees of) parallel to one another and the X and Y directions. Each plate 500, 502 defines a plurality of openings 504 with a prong 506 extending into the opening 504. A plurality of capacitors 508 are positioned between the positive plate 500 and the negative plate 502. Terminals 510 of the capacitors 508 are secured to the prongs 506 on the positive and negative plates 500, 502, such as by welding or other type of fastener. The capacitors 508 are therefore connected in parallel between the positive and negative plates 500, 502.

The positive plate 500 may have sidewalls 512 extending upwardly therefrom substantially (e.g., within 5 degrees of) parallel to the Z direction. The sidewalls 512 may have the positive terminals 400 secured thereto. The sidewalls 512 may therefore function to position the positive terminals 400 substantially (e.g., within 2 mm of) aligned with the negative terminals 402. The positive plate 500 may further have a front wall 514 secured thereto with the positive input terminal 406 secured thereto. The front wall 514 may therefore function to position the positive input terminal 406 substantially (e.g., within 2 mm of) aligned with the negative input terminals 408. In some embodiments, the positive plate 500, sidewalls 512, and front wall 514 are formed of a single piece of metal that is cut and stamped into the illustrated configuration.

The DC link capacitor may further include a positive Y capacitor 516 and a negative Y capacitor 518. The positive Y capacitor 516 provides a capacitive coupling between the positive plate 500 and a ground plane (e.g., the housing 300, which may be electrically coupled to the chassis 106 of the vehicle). The negative Y capacitor 518 provides a capacitive coupling between the negative plate 502 and the ground plane.

The positive plate 500 may define a Y contact 520 that contacts a terminal of the positive Y capacitor 516 when the DC link capacitor 304 is assembled. The negative plate 502 may define a Y contact 522 that contacts a terminal of the negative Y capacitor 518 when the DC link capacitor 304 is assembled. A positive ground connector 524 connects another terminal of the positive Y capacitor 516 to the ground plane and a negative ground connector 526 connects another terminal of the negative Y capacitor 518 to the ground plane. The fasteners 418 may pass through openings 528 in the ground connectors 524, 526 and contact the ground connectors 524, 526 to establish electrical context between the ground connectors 524, 526 and the ground plane.

The DC link capacitor 304 may be contained within a capacitor housing 530. The capacitor housing 530 may be made of plastic or other non-conductive material or may be made of metal and isolated from the DC link capacitor 304 by an insulative layer. The capacitor housing 530 may include a bottom wall 532 substantially (e.g., within 5 degrees of) parallel to the Z direction and a sidewall 534 extending around the perimeter of the bottom wall 532. The sidewall 534 extends upwardly from the bottom wall 532 substantially (e.g., within 5 degrees of) parallel to the Z direction. The sidewall 534 may be substantially parallel to the Z direction with a curved transition portion between the sidewall and the bottom wall 532. The sidewall 534 may be contoured in the X-Y plane to conform to the shape of the sidewalls 512, front wall 514, capacitors 508, and Y-capacitors 516, 518.

As is apparent in FIG. 5A, the sidewall 534 forms lobes 536a, 536b for containing the positive Y capacitor 516 and negative Y capacitor 518, respectively. The lobes 536a, 536b define a recess therebetween. For example, the lobes 536a, 536b may extend outwardly from a front portion 538 of the sidewall 534 (e.g., the portion of sidewall 534 interfacing with the front wall 514) in the Y direction. The lobes 536a, 536b may be offset from one another in the X direction to define the recess 536. The positive Y contact 520 and negative Y contact 522 may extend into the lobes 536a, 536b, respectively, to make contact with terminals of the positive Y capacitor 516 and negative Y capacitor 518, respectively.

Flanges 540 may extend into the recess 536 and define openings 542a (i.e., capacitor fastener openings) for receiving the fasteners 418. The openings 542a may therefore be aligned with the openings 528 of the ground connectors 524, 526 during use. For example, a flange 540 may secure to the lobe 536a and the front portion 538, and a flange 540 may secure to the lobe 536b and the front portion 538. The flanges 540 may define a gap therebetween for receiving the DC choke 410. The flanges 540 may be positioned between the top and the bottom of the sidewall 534 along the Z direction, such as within 0.2H from a midpoint of the sidewall 534 along the Z direction, where H is the height of the sidewall 534 in the Z direction. The housing 530 may define one or more additional openings 542b, such as on protrusions secured to the sidewall 534, to receive additional fasteners securing the housing 530 to the lower housing 300a.

Insulators may be positioned at various locations to prevent electrical contact and arcing between members at the electric potential of the positive plate 500 and members at the electric potential of the negative plate 502. For example, insulators 544a, 544b may be positioned between the sidewall 512 and the upper plate 500 around the positive and negative terminals 400, 402. An insulator 544c may be positioned between the front wall 514 and the upper plate 500 around the positive and negative input terminals 406, 408.

In some embodiments, the positive input terminal 406 extends from an extension 546 formed on the positive plate 500, and the negative input terminal 408 extends from an extension 548 formed on the negative plate 502. The extensions 546, 548 may be substantially (e.g., within 5 degrees of) parallel to the X and Y directions and one another. The extensions 546, 548 may extend outwardly from the front portion 538 of the sidewall 534 along the Z direction. The extensions 546, 548 may be coextensive with one another (e.g., neither extending outwardly from the other by more than 1 mm). In the illustrated embodiment, the positive input terminal 406 is offset from the negative input terminal 408 along the X direction without overlap along the X direction. The insulator 544c, or some other insulator, may extend between the extensions 546, 548. The extensions 546, 548 may also be positioned within the DC choke 410 when the DC link capacitor 304 is assembled. The coextension of the extensions 546, 548 may facilitate canceling of differential mode noise with common mode noise being canceled by the DC choke 410.

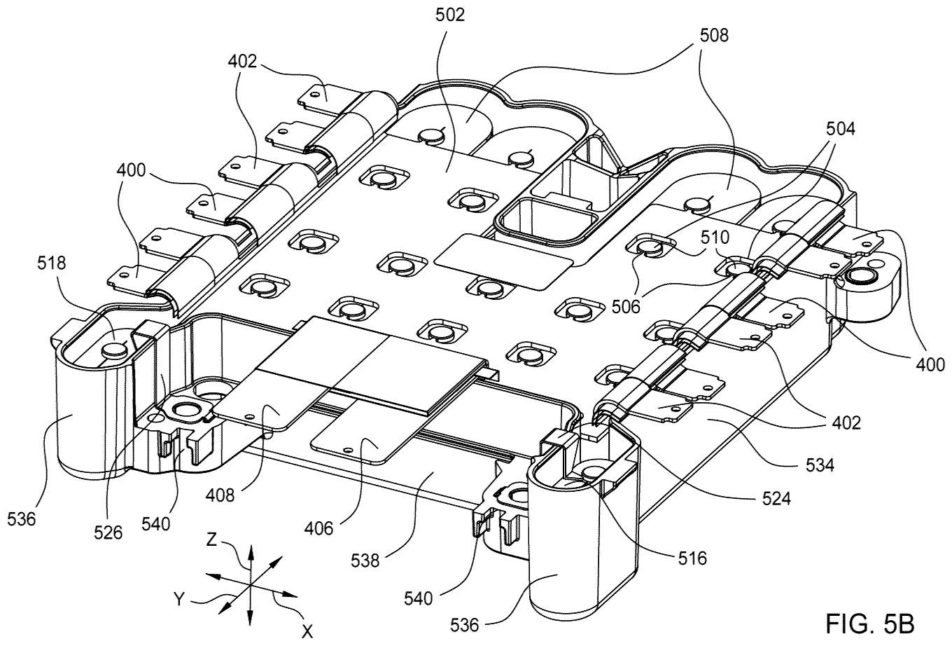

Referring to FIGS. 6 to 9, the DC choke 410 and capacitor housing may include various features to retain the DC choke 410 in position relative to the capacitor housing 530 in absence of the fasteners 418. In particular, the DC choke 410 is passed over the extensions 546, 548 with movement along the Y direction. In contrast, the fasteners 418 insert along the Z direction, which is readily accomplished using commonly available robotic equipment. The features retaining the DC choke 410 may do so without use of a fastening tool. The process of assembling the DC link capacitor 304 is therefore simplified, since insertion of the fasteners 418 can occur along a single direction.

Referring specifically to FIG. 6, the DC choke 410 may include a housing 600 containing a wire coil, laminate, or other inductive structure extending around the opening 412. The housing 600 further defines the opening 412. The opening 412 may be sized to allow the positive extension 546 and negative extension 548 to pass therethrough without resistance. The height of the opening 412 in the Z direction may therefore be slightly (e.g., at least 1, 2, or 4 percent) more than the combined thickness (in the Z direction) of the extensions 546, 548 and an insulative layer positioned therebetween, e.g., a portion of insulator 544c. Likewise, the width of the opening 412 in the X direction may be slightly (e.g., at least 1, 2, or 4 percent) more than the width of the extensions 546, 548 in the X direction. The various features described hereinbelow as being formed on or secured to the housing 600 may be formed by co-molding with the housing 600, e.g., a piece forming part of the housing.

Flanges 602 may extend outwardly from the housing 600, such as outwardly in the X direction. The flanges 602 define openings 604 (i.e., choke fastener openings) for receiving the fasteners. Central axes of the openings 604 may be substantially (e.g., within 5 degrees of) parallel to the Z direction. In the illustrated embodiment, the openings 604 are unthreaded. However, in some embodiments, the openings 604 may be threaded. The size of the openings 604 in the X-Y plane may be slightly (e.g., at least 1, 2, or 4 percent) greater than the diameters of the shafts of the fasteners 418 inserted therein to permit a degree of misalignment without hindering insertion of the fasteners 418, particularly by an automated tool. In the illustrated embodiment, the flanges 602 and openings 604 are positioned offset from the opening 412 in the Z direction, e.g., below the opening 412. However, other arrangements may also be used. The flanges 602 and openings 604 may be positioned along the Z direction between the opening 412 and the lowermost surface of the housing 600. The openings 604 may be include a liner 606, such as a metal liner, to provide strength and possibly create a conductive path between the positive ground connector 524 and the negative ground connector 526 and the lower housing 300a.

The housing 600 may have features formed on or secured thereto that engage with the capacitor housing and one or both of (a) resist removal along the Y direction and (b) resist rotation about an axis substantially (e.g., within 5 degrees of) parallel to the X direction (e.g., in a plane parallel to the Z and Y directions). For example, the housing 600 may have one or both of a fastening feature 608 and an anti-rotation feature 610 secured thereto.

The fastening feature 608 may be embodied as a locking tab including a biasing arm 612 having a guiding surface 614 and a latching surface 616 formed thereon. The biasing arm 612 may extend outwardly from a point of attachment 618 in the Y direction. During use, the biasing arm 612 may bend in the X-Y plane. To that end, the biasing arm may have a greater thickness in the Z direction than in the X direction to promote bending in the X-Y plane over bending in the X-Z or Y-Z planes. The biasing of the biasing arm 612 may be due to inherent elasticity of the biasing arm 612 itself or may be achieved using an arm 612 coupled to the housing 600 by a spring or other biasing member.

The guiding surface 614 and latching surface 616 are secured to the biasing arm 612 distally from the point of attachment 618. The extent of the biasing arm 612 between point of attachment 618 and the latching surface 616 may be chosen to provide a desired degree of biasing force: a shorter arm 612 increasing the biasing force relative to a longer arm 612.

The guiding surface 614 may be implemented as a slanted or sloped surface facilitating insertion of the fastening feature 608. For example, the guiding surface may be slanted or sloped in the X-Y plane and be substantially (e.g., within 2 degrees and/or within 0.1 mm) of parallel to the Z direction. The guiding surface 614 may define an angle of between 10 and 50 degrees relative to the Y direction in the X-Y plane. The latching surface 616 hinders disengagement of the fastening feature 608 and may be oriented substantially (e.g., within 2 degrees of) perpendicular to an insertion direction when installing the DC choke 410, which is the Y direction in the illustrated embodiment. The latching surface 616 may face toward the point of attachment 618. The latching surface 616 may point in the opposite direction from the insertion direction when installing the DC choke 410 onto the capacitor housing 530. The guiding surface 614 is positioned opposite the latching surface 616 and induces deflection of the biasing arm 612 during installation.

In use, once engaged, the latching surface 616 hinders removal of the DC choke 410 from the capacitor housing 530. Specifically, the latching surface 616 hinders movement opposite the insertion direction (“the removal direction”), e.g., along the Y direction in the direction faced by the latching surface 616.

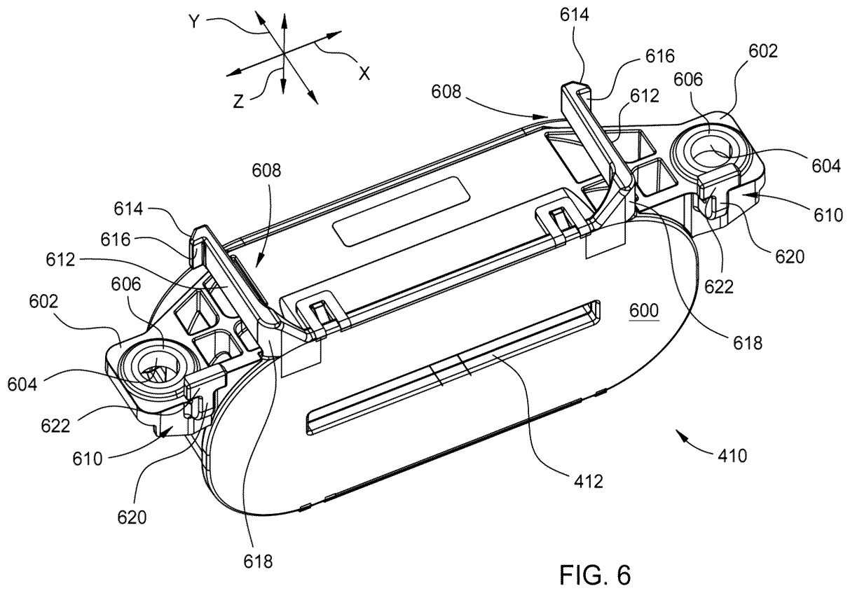

Referring to FIG. 7, the capacitor housing 530 may define one or more features for engaging with the fastening feature 610. For example, for each biasing arm 612 and corresponding guiding surface 614 and latching surface 616, the capacitor housing 530 may define a corresponding guiding surface 702 and latching surface 704. In the illustrated embodiment, a guiding surface 702 and a latching surface 704 are formed on each of the flanges 540, such as on surfaces of the flanges 540 facing inwardly along the X direction. The latching surface 704 faces an opposite direction from the latching surface 616 of the DC choke 410 during use. For example, the latching surface 704 may face substantially parallel to the insertion direction (Y1), e.g., substantially (e.g., within 2 degrees of) parallel to the Y direction along the insertion direction Y1. The guiding surface 702 is positioned opposite the latching surface 704 and may be sloped or slanted in the X-Y plane, e.g., defining an angle of between 10 and 50 degrees relative to the Y direction in the X-Y plane. The guiding surface 614 may be substantially (e.g., within 2 degrees and/or within 0.1 mm of) parallel to the Z direction.

When inserted in the insertion direction Y1 substantially (e.g., within 2 degrees of) parallel to the Y direction, the guiding surface 614 encounters the guiding surface 702, which urges the biasing arm 612 to deflect and enables the guiding surface 614 to slide over the guiding surface 702. Once clear of the guiding surface 702, the biasing arm 612 is biased back to the original configuration thereof and the latching surface 616 engages the latching surface 704, thereby hindering removal along a removal direction Y2 opposite the insertion direction Y1, as shown in FIG. 7.

FIG. 7 further illustrates that each flange 540 may define an opening 706 that receives a portion of the positive ground connector 524 or the negative ground connector 526. The openings 706 may therefore facilitate alignment of the openings 528 of the positive and negative ground connectors 524, 526 with respect to the openings 528.

Referring again to FIG. 6, the anti-rotation feature 610 may hinder rotation of the DC choke 410 either alone or in combination with the fastening feature 608. For example, the anti-rotation feature 610 may resist rotation in the Y-Z plane. The anti-rotation feature 610 may function to limit rotation in the Y-Z plane when the fastening feature 610 is engaged to limit movement along the Y direction.

For example, the anti-rotation feature 610 may be embodied as a protrusion extending outwardly from the housing 600. For example, the anti-rotation feature 610 may extend outwardly in at least the Z direction. In the illustrated embodiment, the anti-rotation feature 610 also protrudes outwardly in the Y direction. The anti-rotation feature 610 may engage a portion of the capacitor housing 430 to resist rotation. The anti-rotation feature 610 may include a narrow portion 620 proximal to the housing 600 and an enlarged portion 622 distal of the narrow portion, the enlarged portion 622 being larger than the narrow portion in at least the X direction. In the illustrated embodiment, the enlarged portion 622 may have a generally cuboid shape with rounded edges. For example, for a cuboid of dimensions L (length)×H (height)×W (width), the edges may be rounded to a radius of between 0.5 and 0.15 W, where W is the smallest of L, W, and H. In the illustrated embodiment, L and H are oriented substantially (e.g., within 5 degrees of) parallel to the X and Z directions, respectively, and W is oriented substantially (e.g., within 5 degrees of) parallel to the Y direction. In the illustrated embodiment, L>H>W, though other configurations are possible.

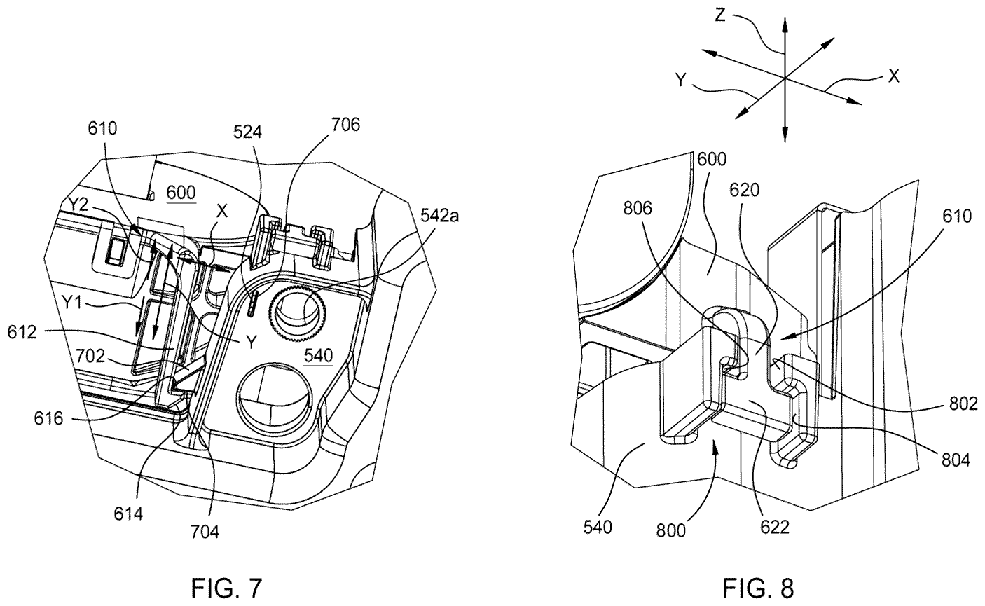

Referring to FIG. 8, while still referring to FIG. 6, the capacitor housing 430 may define a receiver 800 for engaging the anti-rotation feature 610. For example, the receiver 800 may include a narrow portion 802 defining a channel configured to receive the narrow portion 620 and an enlarged portion 804 configured to receive the enlarged portion 622, the enlarged portion 804 being larger than the narrow portion 802 in at least the X direction. In the illustrated embodiment, a receiver 800 is defined on each flange 540, such as a surface of each flange 540 facing in the Y direction. As is apparent, the enlarged portion 804 extends outwardly from the narrow portion 802, such as in the X direction, resulting in a retention surface 806. The retention surface 806 may engage the enlarged portion 622 and hinder rotation of the DC choke 410 relative the capacitor housing 530. The anti-rotation feature 610 may be retained within the receiver 800 due to engagement of the fastening feature 610 with the capacitor housing 530, e.g., the engagement of the latching surface 616 with the latching surface 704. In particular, the receiver 800 may be configured to receive insertion of the anti-rotation feature 610 along the insertion direction Y1 such that resistance to movement in the removal direction Y2 likewise hinders removal of the anti-rotation feature 610 from the receiver 800.

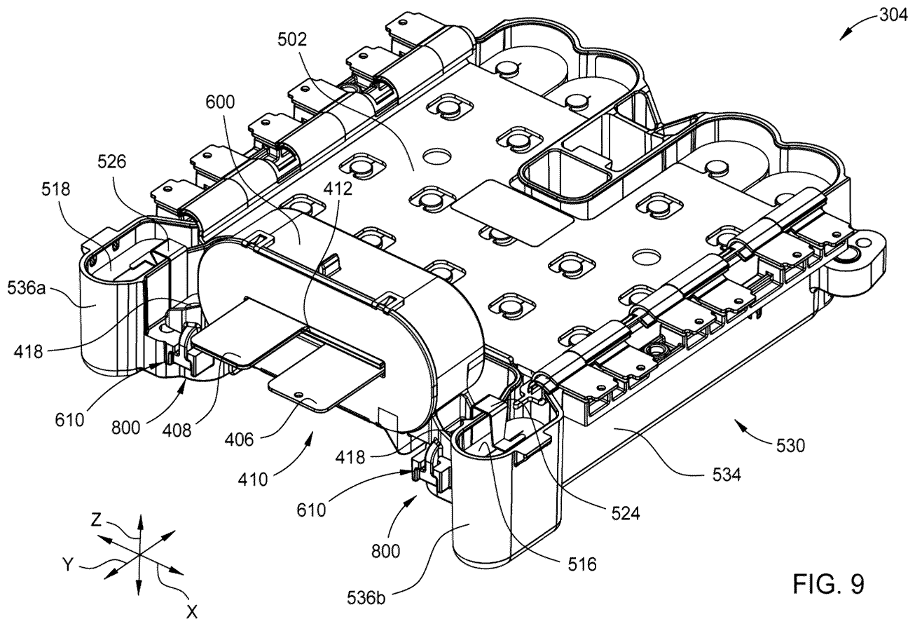

FIG. 9 illustrates the DC choke 410 assembled with the DC link capacitor 304 and capacitor housing 530. When assembled, the fastening feature 610 retains the DC choke 410 relative to the capacitor housing 530, as shown in FIG. 7. The anti-rotation feature 610 engages the receiver 800 to resist rotation in at least the Y-Z plane. In this configuration, the DC choke 410 and DC link capacitor 304 may be handled as a single unit without the need of additional fasteners requiring a tool.

The DC choke 410 and DC link capacitor 304 may then be placed on the lower housing 300a (see FIG. 4A). The fasteners 418 may then be passed through the positive ground connector 524 and negative ground connector 526, through the openings 604, through the openings 542a, and into corresponding openings in the lower housing 300a in order to secure both of the DC choke 410 and DC link capacitor 304 to the lower housing 300a as well as establish electrical contact between the ground plane and the positive Y capacitor 516 and the negative Y capacitor 518. Other fasteners may pass through other openings 542b defined on the housing 530 to secure the housing 530 to the lower housing 300a.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A capacitor assembly, comprising:
a capacitor housing containing a capacitor, the capacitor housing defining at least one capacitor fastener opening and at least one capacitor feature;
a first input terminal of the capacitor;
a second input terminal of the capacitor; and
a direct current (DC) choke defining a terminal opening having the first and second input terminals extending outwardly therefrom, the DC choke defining at least one choke fastener opening configured to receive at least one fastener passing through the at least one capacitor fastener opening, the DC choke further defining at least one choke feature configured to engage the at least one capacitor feature to maintain a position of the DC choke relative to the capacitor housing.

2. The capacitor of claim 1, wherein the at least one choke feature is configured to engage the at least one capacitor feature to maintain the position of the DC choke relative to the capacitor housing in absence of the at least one fastener passing through the at least one choke opening and the at least one capacitor opening.

3. The capacitor assembly of claim 1, wherein:
the terminal opening defines an insertion direction and is configured to receive the first and second input terminals when inserted along the insertion direction;
the at least one choke feature is configured to move along the insertion direction into engagement with the at least one capacitor feature; and
the engagement of the at least one choke feature with the at least one capacitor feature limits rotation of the DC choke relative to the capacitor housing in a plane substantially parallel to the insertion direction.

4. The capacitor assembly of claim 3, wherein:
the at least one capacitor feature comprises a receiver defining a channel and a retention surface extending substantially perpendicularly outwardly from the channel; and
the at least one choke feature comprises a protrusion including a first portion configured to be positioned within the channel and a second portion secured to a distal end of the first portion and extending substantially perpendicularly outwardly from the first portion, the second portion configured to engage the retention surface.

5. The capacitor assembly of claim 1, wherein:
the terminal opening defines an insertion direction and is configured to receive the first and second input terminals when inserted along the insertion direction;
the at least one capacitor feature comprises a first latching portion; and
the at least one choke feature comprises a second latching portion configured to slide into engagement with the first latching portion along the insertion direction.

6. The capacitor assembly of claim 5, wherein the first latching portion comprises a first latching surface substantially perpendicular to the insertion direction and the second latching portion comprises a second latching surface substantially perpendicular to the insertion direction and configured to engage the first latching surface.

7. The capacitor assembly of claim 6, wherein the second latching surface is formed on a biasing arm.

8. The capacitor assembly of claim 1, wherein:
the capacitor is a DC link capacitor;
the DC link capacitor includes a first Y capacitor coupled to the first input terminal, a second Y capacitor coupled to the second input terminal, a first connector coupled to the first Y capacitor positioned between the capacitor housing and the DC choke, and a second connector coupled to the second Y capacitor positioned between the capacitor housing and the DC choke; and
the DC choke is positioned between the first and second Y capacitors.

9. The capacitor assembly of claim 8, wherein the at least one capacitor fastener opening includes a first capacitor fastener opening and a second capacitor fastener opening, and the at least one choke opening includes a first choke fastener opening and a second choke fastener opening, the DC choke including an inductive element positioned between the first choke fastener opening and the second choke fastener opening.

10. The capacitor assembly of claim 9, wherein:
the first connector defines a first connector opening configured to receive a first fastener of the at least one fastener passing through the first choke fastener opening; and
the second connector defines a second connector opening configured to receive a second fastener of the at least one fastener passing through the second choke fastener opening.

11. A method comprising:
moving a direct current (DC) choke over first and second input terminals of a DC link capacitor along an insertion direction while also moving at least one choke feature secured to the DC choke into engagement with at least one capacitor feature secured to the DC link capacitor, the engagement of the at least one choke feature with the at least one capacitor feature resisting movement of the DC choke relative to the DC link capacitor; and
inserting one or more fasteners in a first direction through the DC choke and the DC link capacitor to fasten the DC choke to the DC link capacitor, the first direction being substantially perpendicular to the insertion direction.

12. The method of claim 11, further comprising threading the one or more fasteners into a housing containing one or more sets of power electronics coupled to the DC link capacitor.

13. The method of claim 11, wherein the engagement of the at least one choke feature with the at least one capacitor feature limits rotation of the DC choke relative to the DC link capacitor in a plane substantially parallel to the insertion direction.

14. The method of claim 13, wherein:
the at least one capacitor feature comprises a receiver defining a channel and a retention surface extending substantially perpendicularly outwardly from the channel;
the at least one choke feature comprises a protrusion including a first portion configured to be positioned within the channel and a second portion secured to a distal end of the first portion and extending substantially perpendicularly outwardly from the first portion, the second portion configured to engage the retention surface; and
moving the at least one choke feature into engagement with the at least one capacitor feature comprises moving the first portion into the channel.

15. The method of claim 11, wherein:
the at least one capacitor feature comprises a first latching portion;
the at least one choke feature comprises a second latching portion; and
moving the at least one choke feature secured into engagement with the at least one capacitor feature comprises latching the first latching portion with the second latching portion.

16. The method of claim 15, wherein the first latching portion comprises a first latching surface substantially perpendicular to the insertion direction and the second latching portion comprises a second latching surface substantially perpendicular to the insertion direction and configured to engage the first latching surface;
moving the at least one choke feature secured to the DC choke into engagement with the at least one capacitor feature comprises engaging the first latching surface with the second latching surface.

17. The method of claim 16, wherein the second latching surface is formed on a biasing arm, the method further comprising deflecting the biasing arm to engage the first latching surface with the second latching surface.

18. The method of claim 11, wherein:
a first Y capacitor is coupled to a first input terminal of the DC link capacitor, a second Y capacitor is coupled to a second terminal of the DC link capacitor, a first connector is coupled to the first Y capacitor, and a second connector is coupled to the second Y capacitor; and
the DC choke is positioned between the first and second Y capacitors.

19. The method of claim 18, wherein the DC link capacitor defines a first capacitor fastener opening and a second capacitor fastener opening and the DC choke defines a first choke fastener opening and a second choke fastener opening, the DC choke including an inductive element positioned between the first choke fastener opening and the second choke fastener opening.

20. The method of claim 19, wherein:
the first connector defines a first connector opening;
the second connector defines a second connector opening; and
the method further comprises inserting a first fastener of the one or more fasteners through the first choke fastener opening and the first connector opening and inserting a second fastener of the one or more fasteners through the second choke fastener opening and the second connector opening.
